(19) United States
(12) Patent Application Publication
(10) Pub. No.: US 2014/0298719 A1
(43) Pub. Date: Oct. 9, 2014

(54) SELF CONTAINED PLANT WATERING APPARATUS

(71) Applicant: Robert A. Mackin, Flagstaff, AZ (US)

(72) Inventor: Robert A. Mackin, Flagstaff, AZ (US)

(21) Appl. No.: 13/858,264

(22) Filed: Apr. 8, 2013

(51) Int. Cl. A01G 27/00

(52) U.S. Cl. CPC A01G 27/001
USPC 47/48.5

(57) ABSTRACT

A self contained watering apparatus may be buried within the soil in a conventional decorative pot or outdoors in the ground adjacent a plant(s) to be watered. A container for water serves as the source of water and includes a tube for refilling the container. An electric pump, which may be within the container or above the container, pumps water from within the container and discharges the water through a conventional spray nozzle or drip irrigation nozzle. A battery provides electric power to the pump and a settable timer regulates the electrical connection between the battery and the pump.

### BACKGROUND OF THE INVENTION

1. Field of the Invention

The present invention relates to watering systems and, more particularly, to a self contained plant watering apparatus.

2. Description of the Prior Art

Plants in pots, whether indoor or outdoor, require periodic manual watering to sustain life and growth of the plant(s) in the pot. Similarly, plants outdoors require a certain amount of water as a function of the type and nature of the plant. Often, natural rainfall may be insufficient and without sufficient watering, the plants will die. To solve the problem of watering outdoor plants, various irrigation systems are used. For residential use, buried conduits discharging water through nozzles in the form of a spray or in the manner of drip irrigation are often used. More simplistic watering apparatus includes the use of a conventional hose discharging water through a stationary or rotating sprinkler. The underground watering systems generally include a timer to cause the discharge of water at periodic intervals for preset durations. The use a conventional above ground hose and sprinkler usually requires manually laying the hose, attaching the sprinkler thereto, and turning on a hose bib or the like. To cease watering, the process is reversed. These watering systems are used outdoors and no equivalent unattended watering system is available for indoor potted plants. Furthermore, outdoor plants at a location distant from a residence are generally manually watered from time to time to avoid the expense associated with a significant length of above ground or buried conduit and attendant water discharge outlets, whether of the spray or drip irrigation type.

### SUMMARY OF THE INVENTION

A water container of any selected size is buried within the soil of a pot to provide a source of water for the plant(s) growing in the pot. An electric motor operated pump draws water through a conduit within the container for discharge through the outlet of a further conduit. A battery provides electrical power to the motor of the pump and a timer regulates the frequency and duration of the electrical connection between the battery and the electric motor. Thereby, the plant within the pot will be watered in accordance with a preset schedule for a period of time commensurate with the presence of water in the container. To replenish the water in the container, a fill tube in communication with the container extends above the level of the soil for this purpose. A sensor may be incorporated in the container to provide a visual or audible indication of the level of water within the container. From this description, it is evident that the watering apparatus will operate unattended for a period of time as a function of the frequency of water discharge and the water capacity of the container.

For outdoor plants, the container may be buried in proximity to the plant or plants to be watered. This will alleviate the necessity for using buried or above ground conduits extending from a source of water, such as a hose bib, to the plant or plants to be watered. Furthermore, these outdoor plants will be watered unattended for a period of time commensurate with the amount of water in the container and frequency and duration of water discharge set by the timer.

It is therefore a primary object of the present invention to provide an unattended automatic self contained plant watering apparatus.

Another object of the present invention is to provide a plant watering apparatus that may be buried in indoor pots.

Still another object of the present invention is to provide buried apparatus for automatically watering outdoor plants at any location.

Yet another object of the present invention is to provide a plant watering apparatus independent of any external water pipes or conduits.

A further object of the present invention is to provide an inexpensive self contained plant watering apparatus.

A yet further object of the present invention is to provide a self contained plant watering apparatus having a submersible pump.

A still further object of the present invention is to provide a self contained plant watering apparatus having an indicator for reflecting the quantity of water in a water container.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a pot for a plant having the self contained plant watering apparatus disposed therein;

FIG. 2A illustrates a representative cross-sectional view of the watering apparatus disposed within a pot;

FIG. 2B is a representative cross-sectional view of a self contained plant watering apparatus having a pump disposed at the bottom of a water container;

FIG. 3A illustrates use of a self contained plant watering apparatus disposed beneath the surface of the soil and in proximity to a plant or plants to be watered;

FIG. 3B illustrates a variant of the invention shown in FIG. 3A wherein the pump is disposed within the water container; and

FIG. 4 is similar to FIG. 3B but illustrates the use of a sensor for sensing the level of water within the container.

### DESCRIPTION OF THE PREFERRED EMBODIMENT

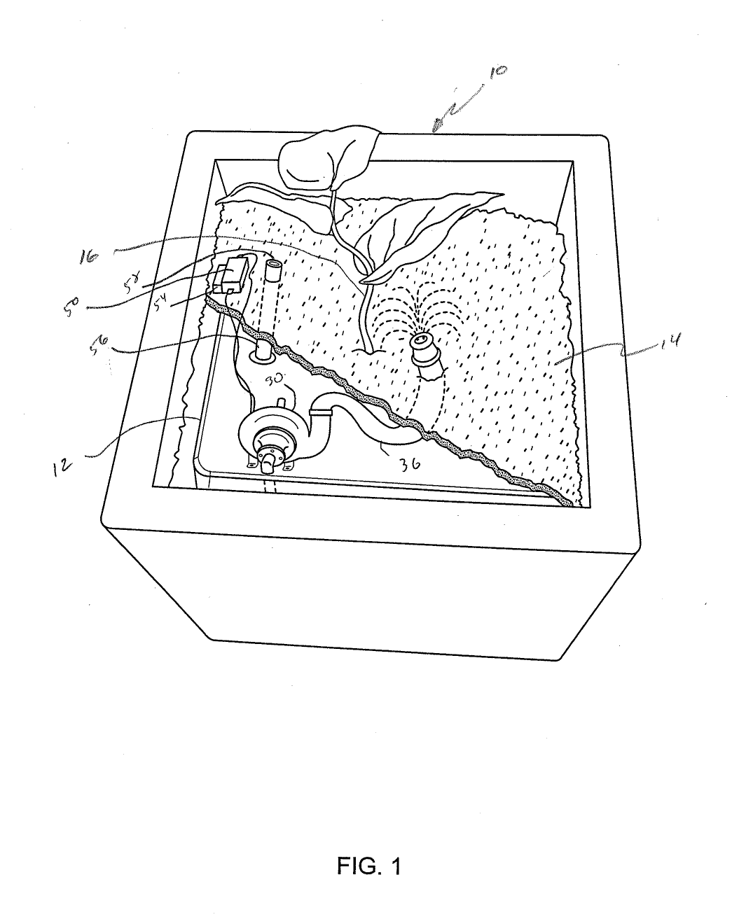

Referring to FIG. 1, there is shown a conventional pot 10 of the type usually used for growing plants. A container 12 is located within the pot to provide a source of water for the plants growing in the pot. Necessarily, the size of the container is selected as a function of the size of the pot and the quantity of water to be stored therein. Soil 14 is deposited in the pot to provide nourishment for plants 16 growing in the pot. It is self-evident that container 12 must be of a size small enough to provide sufficient soil within the pot for the plant(s) to grow and flourish.

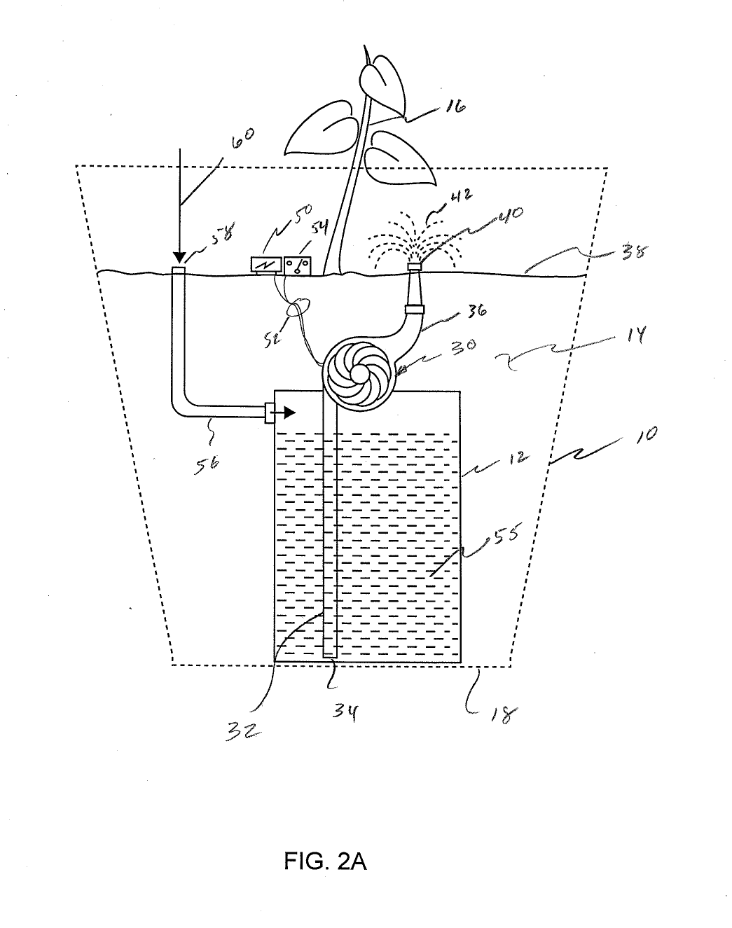

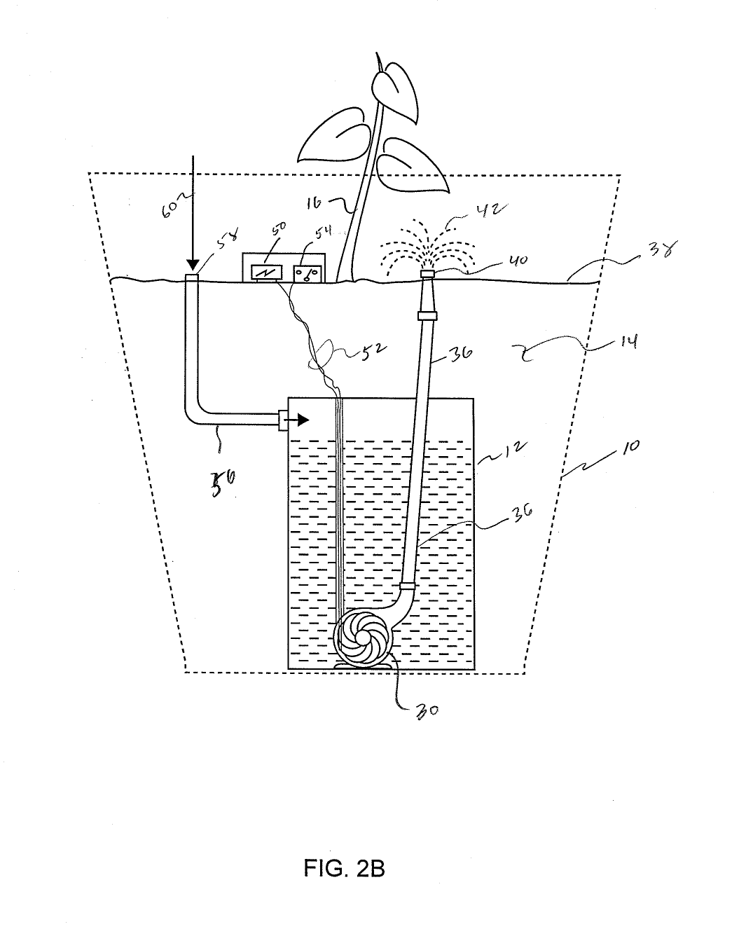

Referring jointly to FIGS. 1 and 2A, further details will be described. Container 12 is expected to rest on bottom 18 of pot 10, as illustrated. Soil 14 is deposited around the container to provide the necessary nutrients to plant 16. A pump 30 draws water from within container 12 through a conduit 32 having an inlet 34 proximate the bottom of the container. It is to be understood that the pump is operated by an electric motor; the term pump is used herein in the sense that the electric motor and pump are a combined unit. Outflow from pump 30 is discharged through a further conduit 36 to a location above level 38 of soil 14. The outlet of conduit 36 may include a nozzle 40 to provide a spray of water, depicted by numeral 42. Alternatively, the nozzle may be of the type providing drip irrigation to reduce losses due to evaporation common with sprays. The discharged water, whether by spray or drip, provides the necessary water for plant 16. It is anticipated that nutrients may be dissolved in the water in the container to assist and promote plant growth.

Electrical power for the pump and its attached electric motor is provided by a battery 50 through electrical conductors 52. A timer 54 is employed to regulate both the duration and frequency of electrical power provided to pump 30. Thereby, the quantity and frequency of water discharged through nozzle 40 may be preset commensurate with the requirements of plant 16 and considerations of weather.

After a period of time, all of water 55 within container 12 will have been consumed, or nearly so. A tube 56 is in fluid communication with the interior of container 12 and extends upwardly, preferably above level 38 to provide access to inlet 58 of tube 56. As depicted by arrow 60, water may be injected through inlet 58 to fill container 12. Necessarily, the battery will have to be either replaced or recharged from time to time.

By inspection, it becomes evident that plant 16 will receive a quantity of water, as necessary and set by timer 54 to avoid periodic manual watering. Thereby, soil 14 will provide the necessary moisture for an extended period of time as a function of the size of container 12 and the quantity of water contained therein. Thus, the plant watering apparatus may remain unattended for a period of time without compromising the growth and health of the associated plants.

Referring to FIG. 2B, there is shown a plant watering apparatus similar to that shown in FIG. 2A except that pump 30 and its associated electric motor is mounted at the bottom of container 12. Water discharged from the pump is directed upwardly through conduit 36 to nozzle 40 generally locatable above level 38 of soil 14. Power for the electric motor associated with pump 30 is provided by electrical conductors 52 extending into container 12 for connection with the electric motor of pump 30. Battery 50 and timer 54 operate in the same manner as described above to control the frequency and duration of operation of pump 30. While nozzle 40 is depicted as providing a spray 42, it can also include the nozzle for providing drip irrigation, as discussed above.

The self contained plant watering apparatus described above is primarily directed to apparatus for use within a pot, whether indoors or outdoors. Some plants may be located outdoors at some distance from a source of water, such as a hose bib or the like. To avoid running conduit above or below ground to plants to be watered, the present invention may be employed.

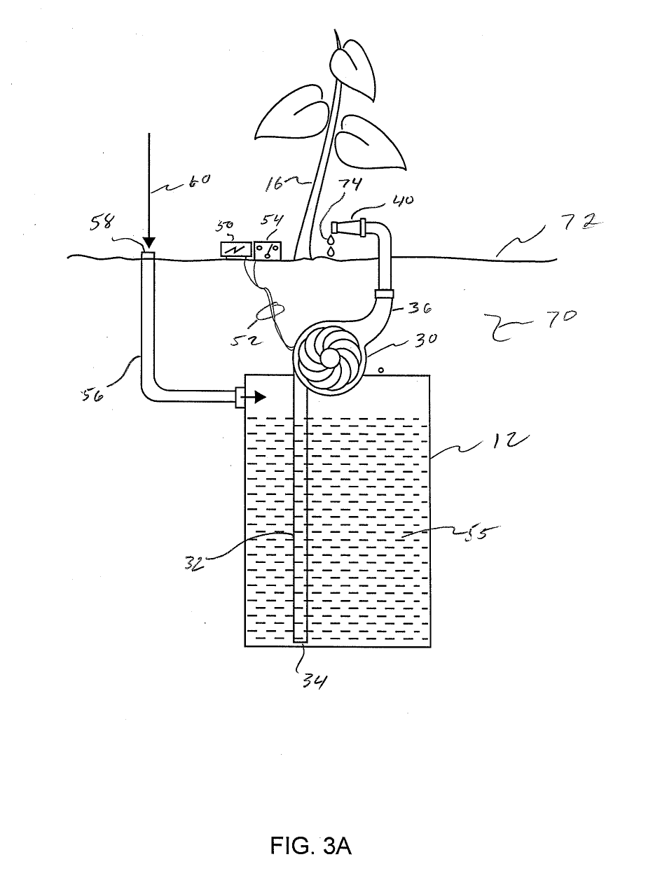

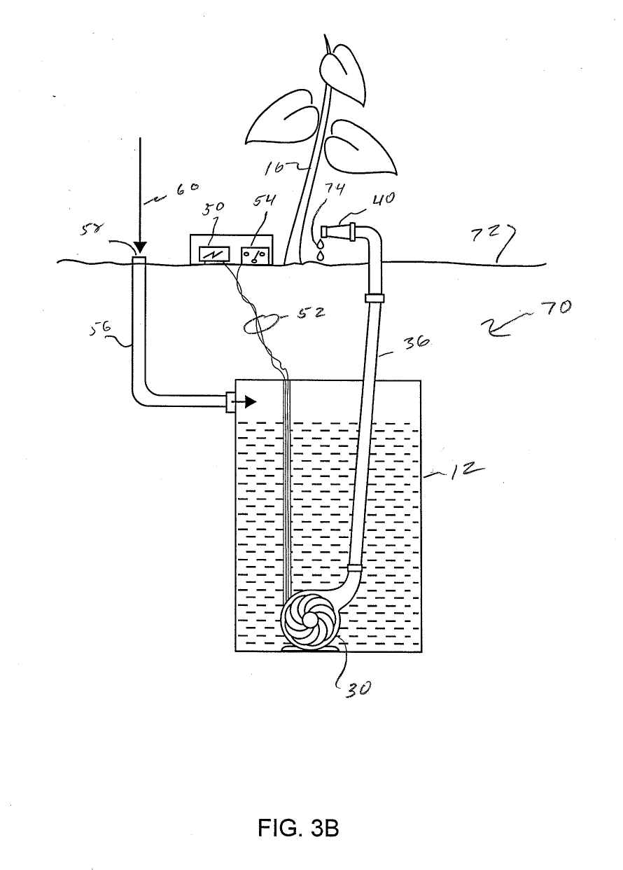

As depicted in FIG. 3A, container 12 is buried in the ground, as reflected by numeral 70 and ground surface 72. The container may be periodically filled through inlet 58 of tube 56, as depicted by arrow 60. Pump 30 and its associated electrical motor draws water from within container 12 through conduit 32 having an inlet 34 close to the bottom of container 12. The pump discharges water through conduit 36 to a nozzle 40 configured to provide drip irrigation to plant 16, as depicted by droplets 74. Power for pump 30 is provided by battery 50. Control of operation of the pump is provided by timer 54.

The self contained plant watering apparatus depicted in FIG. 3A can easily be used outdoors to provide water and other nutrients to associated plants for a period of time as a function of the size of container 12 and quantity of water 55 therein coupled with operation of timer 54.

FIG. 3B depicts a self contained plant watering system as shown in FIG. 3A except that pump 30 and its associated electric motor are mounted at the bottom of container 12. Electric power is provided to the motor of pump 30 via conductors 52 extending into container 12 and interconnecting the motor of pump 30 with battery 50 and/or timer 54. Water discharge from pump 30 is provided by conduit 36 terminated by nozzle 40. As depicted, the nozzle may be configured to provide drip irrigation, represented by drops 74. It is to be understood that the nozzle may provide a spray, as depicted in FIGS. 1, 2A and 2B. Periodic filling of container 12 may be via tube 56 having an accessible inlet 58 above ground. Such filling of water, with or without nutrients, is represented by arrow 60. The configuration of the self contained plant watering system illustrated in FIG. 3B provides benefits similar to that described above with respect to the self contained plant watering system shown in FIG. 3A. The main difference is that the pump is located within container 12 rather than exterior of container 12, as depicted in FIG. 3A. That is, conduit 32 shown in FIG. 3A, extends from within container 12 to pump 30 exterior of the container while pump 30, as depicted in FIG. 3B, draws water from within the container and discharges the water through conduit 36 extending from the submerged pump to a location outside of the container and preferably above level 72 of ground 70.

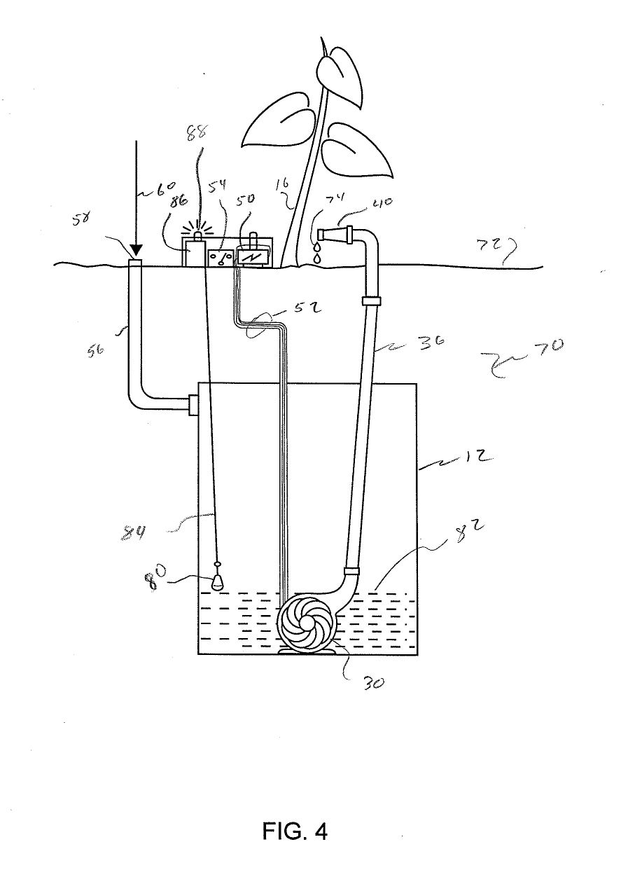

Referring to FIG. 4, there is illustrated a plant watering apparatus similar to that shown in FIG. 3B and described above but including a further feature. A water level sensor 80 extends into container 12 to a depth representative of low water in the container. When the water level 82 results from previous discharge of water, the sensor will generate a signal representative of water level 82. This signal is conveyed through a conductor 84 to an alarm circuit 86. The alarm circuit, when triggered by sensor 80, will provide a visual indication of a low water level condition within container 12, as represented by flashing light 88. It is to be understood that an audible signal may be generated in place of or in combination with energization of light 88. Upon the presence of either or both the visual or audible signals, container 12 should be filled with water through inlet 58, as depicted by arrow 60. It is intended that this sensor unit may also be used in the embodiments shown in FIGS. 1, 2A, 2B, 3A and 3B.

I claim:

1. A self contained watering apparatus for a plant, said apparatus comprising:
(a) a container for water to be buried in the soil proximate the plant(s) to be watered, said container including a tube for refilling said container;
(b) an electric pump for pumping water from said container through an outlet in proximity to the plant to be watered;
(c) a battery for providing power to energize said pump; and
(d) a timer for controlling energization and operation of said pump.

2. The apparatus as set forth in claim 1 wherein said outlet includes a nozzle for providing a spray of water.

3. The apparatus as set forth in claim 1 wherein said outlet includes a nozzle for providing drip irrigation.

4. The apparatus as set forth in claim 1 wherein said pump is disposed above said container and including an inlet conduit for conveying water from said container to said pump.

5. The apparatus as set forth in claim 4 wherein said battery is disposed above said container.

6. The apparatus as set forth in claim 5 wherein said timer is disposed above said container.

7. The apparatus as set forth in claim 1 wherein said pump is disposed within said container and including electrical conductors for interconnecting said battery with said pump and a conduit interconnecting said pump with said outlet.

8. The apparatus as set forth in claim 1 wherein said container is buried in the soil in a conventional pot for periodically watering one or more plants in the pot.

9. The apparatus as set forth in claim 1 wherein said container is located in-ground proximate any plant to be periodically watered.

10. The apparatus as set forth in claim 1 including a sensor for sensing the water level within said container.

11. A method for automatically periodically watering one or more plants from a self contained watering apparatus, said method comprising the steps of:
(a) providing a source of water from a container below the surface of the soil adjacent the plant or plants to be watered;
(b) pumping water from within the container with a pump and through a conduit terminated by an outlet proximate the plant or plants to be watered;
(c) energizing the pump with electric power from a battery;
(d) controlling operation of said step of energizing with a settable timer; and
(e) refilling the container through a tube having an inlet above the container.

12. The method as set forth in claim 11 wherein the pump is located above the container and including the step of drawing water from within the container through a conduit.

13. The method as set forth in claim 11 wherein the pump is located within the container and including the step of drawing water directly into the pump, the step of discharging the water into the conduit, and the step of locating electrical conductors within the container to interconnect the battery with the pump.

14. The method as set forth in claim 11 including the step of discharging water from the outlet in the form of a spray.

15. The method as set forth in claim 11 including the step of discharging water from the outlet in the form of drip irrigation.

16. The method as set forth in claim 13 including the step of discharging water from the outlet in the form of a spray.

17. The method as set forth in claim 11 including the step of sensing the water level within the container with a sensor.

18. Apparatus for periodically watering one or more plants growing indoors out of the soil in a pot or outdoors out of the soil, said apparatus comprising:
(a) a container for water disposed beneath the surface of the soil;
(b) a pump for pumping water out of said container and into a conduit;
(c) an outlet for discharging water from said conduit in the form of a spray or in the manner of drip irrigation;
(d) a battery for providing electric power to said pump and energize said pump;
(e) a timer for periodically interconnecting said battery with said pump;
(f) a sensor for sensing the level of water in said container; and
(g) a tube for refilling the container.

19. The apparatus as set forth in claim 18 wherein said pump is located within said container and including electrical conductors disposed within said container for conveying electrical power from said battery to said pump.
